(19) United States
(12) Patent Application Publication
(10) Pub. No.: US 2026/0259734 A1
(43) Pub. Date: Sep. 3, 2026

(54) COMPUTER-IMPLEMENTED METHOD, AND DEVICE FOR PROVIDING BINARY INSTRUCTIONS

(71) Applicant: Robert Bosch GmbH, Stuttgart (DE)

(72) Inventor: Jan Micha Borrmann, Mannheim (DE)

(21) Appl. No.: 19/159,788

(22) PCT Filed: Feb. 19, 2024
(86) PCT No.: PCT/EP2024/054154

§ 371 Date: Sep. 26, 2025

(30) Foreign Application Priority Data
Mar. 8, 2023 (DE) 10 2023 202 066.1

(51) Int. Cl. G06F 9/30; G06F 9/38

(52) U.S. Cl. CPC G06F 9/30145; G06F 9/30018; G06F 9/3877

(57) ABSTRACT

A computer-implemented or hardware-implemented method and to a device for the automated, diversely redundant execution of binary instructions. The device includes a first processor having a first architecture and a second processor having a second architecture. The first processor is designed to execute binary instructions of a first format, and the second processor is designed to execute binary instructions of a second format different from the first format. The device is designed to provide the first processor with at least one binary instruction in the first format and to provide the second processor with at least one binary instruction in the second format that is redundant to the at least one first binary instruction.

### FIELD

The present invention relates to a computer-implemented method and to a device for providing binary instructions.

### BACKGROUND INFORMATION

A conventional processor is designed to execute binary instructions provided to the processor.

A user of the processor is provided with an option for providing binary instructions for execution on the processor. On the one hand, these binary instructions can be provided in a specified format suitable for execution on the processor. On the other hand, it can be provided that these binary instructions are provided by the user in a format different from the specified format and are translated into binary instructions executable by the processor in the specified format.

For creating redundancy, multiple processors are used, which are designed to execute the binary instructions in the specified format. These processors can have the same architecture or different architectures that can execute binary instructions in the specified format.

### SUMMARY

According to an example embodiment of the present invention, a device for the automated, diversely redundant execution of binary instructions provides that the device comprises a first processor having a first architecture and a second processor having a second architecture, wherein the first processor is designed to execute binary instructions of a first format, wherein the second processor is designed to execute binary instructions of a second format different from the first format, wherein the device is designed to provide the first processor with at least one binary instruction in the first format and to provide the second processor with at least one binary instruction in the second format that is redundant to the at least one first binary instruction, wherein the device is designed either to receive the at least one binary instruction of the first format and to determine the at least one binary instruction of the second format depending on the at least one binary instruction of the first format, or to receive a binary instruction redundant to the at least one binary instruction of the first format and to the at least one binary instruction of the second format, in a third format for binary instructions that is different from the first format and from the second format, and to determine the at least one binary instruction of the first format and the at least one binary instruction of the second format depending on the binary instruction of the third format. The formats are specified, for example, by different instruction set architectures, ISA. On the one hand, a translation of the first binary instruction into the second binary instruction can be provided, wherein the first binary instruction and the second binary instruction are each provided to one of the processors. On the other hand, a translation of the first binary instruction into the third binary instruction can be provided, wherein the second binary instruction and the third binary instruction are each provided to one of the processors. The architectures are, for example, different microprocessor core architectures, μArch. The device provides diverse redundancy through processors of different architectures and formats. The first binary instructions are diversely redundant to the second binary instructions. This improves robustness to systematic errors.

According to an example embodiment of the present invention, the device is preferably designed to provide the at least one binary instruction of the first format to the first processor for translation, wherein the first processor is designed to provide the at least one binary instruction of the second format depending on the at least one instruction of the first format, or that the device is designed to provide the at least one binary instruction of the third format to the first processor for translation, wherein the first processor is designed to provide the at least one binary instruction of the first format and the at least one binary instruction of the second format depending on the binary instruction of the third format. This avoids the need for an additional processor.

According to an example embodiment of the present invention, the device is preferably designed to provide the at least one binary instruction of the first format to a third processor for translation, wherein the third processor is designed to provide the at least one binary instruction of the second format depending on the at least one binary instruction of the first format. The device is preferably designed to provide the binary instruction of the third format to the third processor for translation, wherein the third processor is designed to provide the at least one binary instruction of the first format and the at least one binary instruction of the second format depending on the binary instruction of the third format. This avoids putting a load on the other processors with the translation.

Preferably, according to an example embodiment of the present invention, it is provided that the third processor is configurable for a translation of the at least one binary instruction of the first format into the at least one binary instruction of the second format, wherein the device is designed to configure the third processor for the translation of the at least one binary instruction of the first format into the at least one binary instruction of the second format, or that the third processor is configurable for a translation of the at least one binary instruction of the third format into the at least one binary instruction of the first format, wherein the device is designed to configure the third processor for the translation of the at least one binary instruction of the third format into the at least one binary instruction of the first format, or that the third processor is configurable for a translation of the at least one binary instruction of the third format into the at least one binary instruction of the second format, wherein the device is designed to configure the third processor for the translation of the at least one binary instruction of the third format into the at least one binary instruction of the second format.

This means that the processors provided for the diversely redundant execution of the binary instructions are not additionally loaded with the translation. The third processor can be designed according to an architecture for accelerated translation.

In one example embodiment of the present invention, the device comprises a memory in which instructions for translating the at least one binary instruction of the first format into the at least one binary instruction of the second format are stored, wherein the device is designed to read the instructions from the memory and to determine the at least one binary instruction of the second format depending on the instructions and the at least one binary instruction of the first format. In one embodiment, the device comprises a memory in which instructions for translating the at least one binary instruction of the third format into at least one binary instruction of the first format are stored, wherein the device is designed to read the instructions from the memory and to determine the at least one binary instruction of the first format depending on the instructions and the at least one binary instruction of the third format. In one embodiment, the device comprises a memory in which instructions for translating the at least one binary instruction of the third format into the at least one binary instruction of the second format are stored, wherein the device is designed to read the instructions from the memory and to determine the at least one binary instruction of the second format depending on the instructions and the at least one binary instruction of the third format. This makes it possible to determine previously unknown translation results.

According to an example embodiment of the present invention, it can be provided that the device comprises a memory in which a translation result of a translation of the at least one binary instruction of the first format into the at least one binary instruction of the second format is stored, wherein the device is designed to read the translation result from the memory and to determine the at least one binary instruction of the second format depending on the translation result, or that the device comprises a memory in which a translation result of a translation of the at least one binary instruction of the third format into the at least one binary instruction of the first format is stored, wherein the device is designed to read the translation result from the memory and to determine the at least one binary instruction of the first format depending on the translation result, or that the device comprises a memory in which a translation result of a translation of the at least one binary instruction of the third format into the at least one binary instruction of the second format is stored, wherein the device is designed to read the translation result from the memory and to determine the at least one binary instruction of the second format depending on the translation result. This speeds up the translation.

According to an example embodiment of the present invention, it can be provided that the memory comprises a table for the translation result, which table assigns the at least one binary instruction of the second format to the at least one binary instruction of the first format, wherein the device is designed to provide the at least one binary instruction of the second format assigned to the at least one binary instruction of the first format in the table as the translation result, or that the memory comprises a table for the translation result, which table assigns the at least one binary instruction of the first format to the at least one binary instruction of the third format, wherein the device is designed to provide the at least one binary instruction of the first format assigned to the at least one binary instruction of the third format in the table as the translation result, or that the memory comprises a table for the translation result, which table assigns the at least one binary instruction of the second format to the at least one binary instruction of the third format, wherein the device is designed to provide the at least one binary instruction of the second format assigned to the at least one binary instruction of the third format in the table as the translation result. This further speeds up the translation.

It can be provided that the device is designed to determine that the translation result for the translation is stored in the memory and to read the translation result from the memory, or to determine that the translation result for the translation is unknown in the memory and to calculate the translation result depending on the instructions and to store it in the memory. This allows unknown translation results to be calculated and stored for later translations, or allows existing translation results to be reused.

In one example embodiment of the present invention, it is provided that the first processor or the second processor comprises a hardware accelerator, wherein the device is designed to determine a configuration of the hardware accelerator depending on the at least one binary instruction of the first format or the at least one binary instruction of the third format. This means that instructions are translated into the configuration.

According to an example embodiment of the present invention, a computer-implemented or hardware-implemented method for the automated, diversely redundant execution of binary instructions provides that at least one binary instruction in the first format is provided to a first processor, which has a first architecture and is designed to execute binary instructions of a first format, and at least one binary instruction in the second format, which is redundant to the at least one binary instruction of the first format, is provided to a second processor, which has a second architecture different from the first architecture and is designed to execute binary instructions of a second format different from the first format, wherein the at least one binary instruction of the first format is received and the at least one binary instruction of the second format is determined depending on the at least one binary instruction of the first format, or a binary instruction redundant to the at least one binary instruction of the first format and to the at least one binary instruction of the second format, in a third format for binary instructions that is different from the first format and from the second format is received and the binary instruction of the first format and the binary instruction of the second format are determined depending on the binary instruction of the third format. This makes it possible to execute the provided binary instructions in a manner secured redundantly against systematic errors in one of the architectures or formats.

The following developments of the method of the present invention have advantages that correspond to those of the developments of the device of the present invention.

Preferably, it is provided that the at least one binary instruction of the first format is provided to the first processor for translation, wherein the at least one binary instruction of the second format is provided by means of the first processor depending on the at least one instruction of the first format, or that the at least one binary instruction of the third format is provided to the first processor for translation, wherein the at least one binary instruction of the first format and the at least one binary instruction of the second format are provided by means of the first processor depending on the binary instruction of the third format.

Preferably, it is provided that the at least one binary instruction of the first format is provided to a third processor for translation, wherein the at least one binary instruction of the second format is provided by means of the third processor depending on the at least one binary instruction of the first format, or that the binary instruction of the third format is provided to the third processor for translation, wherein the at least one binary instruction of the first format and the at least one binary instruction of the second format are provided by means of the third processor depending on the binary instruction of the third format.

Preferably, it is provided that the third processor is configurable for a translation of the at least one binary instruction of the first format into the at least one binary instruction of the second format, wherein the third processor is configured for the translation of the at least one binary instruction of the first format into the at least one binary instruction of the second format, or that the third processor is configurable for a translation of the at least one binary instruction of the third format into the at least one binary instruction of the first format, wherein the third processor is configured for the translation of the at least one binary instruction of the third format into the at least one binary instruction of the first format, or that the third processor is configurable for a translation of the at least one binary instruction of the third format into the at least one binary instruction of the second format, wherein the third processor is configured for the translation of the at least one binary instruction of the third format into the at least one binary instruction of the second format.

Preferably, it is provided that instructions for translating the at least one binary instruction of the first format into the at least one binary instruction of the second format are stored in a memory, wherein the instructions are read from the memory and the at least one binary instruction of the second format is determined depending on the instructions and the at least one binary instruction of the first format, or that instructions for translating the at least one binary instruction of the third format into at least one binary instruction of the first format are stored in a memory, wherein the instructions are read from the memory and the at least one binary instruction of the first format is determined depending on the instructions and the at least one binary instruction of the third format, or that instructions for translating the at least one binary instruction of the third format into the at least one binary instruction of the second format are stored in a memory, wherein the instructions are read from the memory and the at least one binary instruction of the second format is determined depending on the instructions and the at least one binary instruction of the third format.

Preferably, it is provided that a translation result of a translation of the at least one binary instruction of the first format into the at least one binary instruction of the second format is stored in a memory, wherein the translation result is read from the memory and the at least one binary instruction of the second format is determined depending on the translation result, or in that a translation result of a translation of the at least one binary instruction of the third format into the at least one binary instruction of the first format is stored in a memory, wherein the translation result is read from the memory and the at least one binary instruction of the first format is determined depending on the translation result, or in that a translation result of a translation of the at least one binary instruction of the third format into the at least one binary instruction of the second format is stored in a memory, wherein the translation result is read from the memory and the at least one binary instruction of the second format is determined depending on the translation result.

Preferably, it is provided that the memory comprises a table for the translation result, which table assigns the at least one binary instruction of the second format to the at least one binary instruction of the first format, wherein the at least one binary instruction of the second format assigned to the at least one binary instruction of the first format in the table is provided as the translation result, or that the memory comprises a table for the translation result, which table assigns the at least one binary instruction of the first format to the at least one binary instruction of the third format, wherein the at least one binary instruction of the first format assigned to the at least one binary instruction of the third format in the table is provided as the translation result, or that the memory comprises a table for the translation result, which table assigns the at least one binary instruction of the second format to the at least one binary instruction of the third format, wherein the at least one binary instruction of the second format assigned to the at least one binary instruction of the third format in the table is provided as the translation result.

Preferably, it is provided that the translation result for the translation is stored in the memory and the translation result is read from the memory, or that it is determined that the translation result for the translation is unknown in the memory and the translation result is calculated depending on the instructions and stored in the memory.

Preferably, the first processor or the second processor comprises a hardware accelerator, wherein a configuration of the hardware accelerator is determined depending on the at least one binary instruction of the first format or the at least one binary instruction of the third format.

According to the present invention, a computer program comprises computer-readable instructions, upon the execution of which by a computer the method of the present invention is carried out. This program has advantages that correspond to those of the method of the present invention.

Further advantageous embodiments of the present invention can be found in the following description and the figures.

### BRIEF DESCRIPTION OF THE DRAWINGS

FIG. 1 is a schematic representation of a first embodiment of a device for providing binary instructions, according to the present invention.

FIG. 2 is a schematic representation of a second embodiment of the device for providing binary instructions, according to the present invention.

FIG. 3 is a schematic representation of a third embodiment of the device for providing binary instructions, according to the present invention.

FIG. 4 is a schematic representation of a fourth embodiment of the device for providing binary instructions, according to the present invention.

FIG. 5 shows a first embodiment of a method for providing binary instructions, according to the present invention.

FIG. 6 shows a second embodiment of the method for providing binary instructions, according to the present invention.

### DETAILED DESCRIPTION OF EXAMPLE EMBODIMENTS

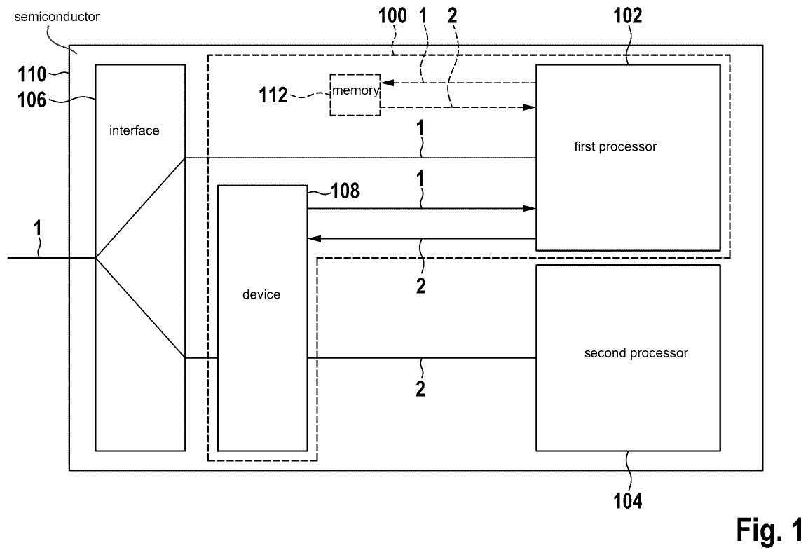

FIG. 1 schematically shows a first embodiment of a device 100 for providing binary instructions.

The device 100 comprises a first processor 102 having a first architecture and a second processor 104 having a second architecture different from the first architecture.

The device 100 comprises an interface 106. The interface 106 is designed to receive a first binary instruction 1 in a first format for binary instructions.

The device 100 comprises a device 108, which is designed to provide the first binary instruction 1 and a second binary instruction 2 in a second format different from the first format.

The device 108 is designed to provide the first binary instruction 1 in the first format for binary instructions.

The first processor 102 is designed to execute instructions in the first format. In the example, the first processor 102 is unsuitable for executing binary instructions in the second format.

The second processor 104 is designed to execute instructions in the second format. In the example, the second processor 104 is unsuitable for executing binary instructions in the first format.

The device 108 is designed to receive the first binary instruction 1 at the interface 106 and to determine the second binary instruction 2 depending on the first binary instruction 1.

The device 108 is designed to provide an instruction to be translated, i.e., the first binary instruction 1, to the first processor 102 for translation. The first processor 102 is designed to provide a translated binary instruction, i.e., the second binary instruction 2, depending on the instruction to be translated.

The first processor 102, the second processor 104 and the device 108 are integrated on a semiconductor 110 in the example. The semiconductor 110 can also comprise the interface 106, as shown in FIG. 1. The interface 106 can also be arranged outside the semiconductor. It can be provided that the device 108 is arranged outside the semiconductor 110. It can be provided that one semiconductor 110 is provided for each processor.

In the example, an output of a result of an execution of an instruction provided to the particular processor is provided through the interface 106.

The device 100 optionally comprises a memory 112.

The memory 112 stores instructions for translating binary instructions of one format into translated binary instructions of another format.

In the first embodiment, instructions for translating binary instructions from the first format to the second format are stored.

The first processor 102 is designed to read the instructions from the memory 112 and to determine the translated binary instruction depending on the instructions.

In the example, the instructions comprise a table that assigns a binary instruction of the second format to a binary instruction to be translated of the first format. The first processor 102 is designed to find the translated second binary instruction assigned to the first binary instruction to be translated in the table and to provide it to the device 108.

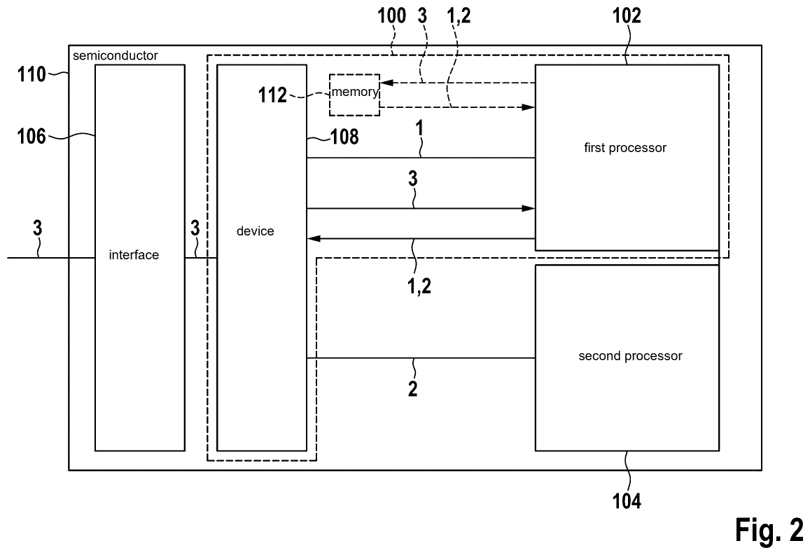

FIG. 2 schematically shows a second embodiment of the device 100 for providing binary instructions.

In contrast to the first embodiment, the interface 106 in the second embodiment is designed to receive a third binary instruction 3.

In contrast to the first embodiment, the device 108 in the second embodiment is designed to receive the third binary instruction 3 at the interface 106 and to determine the first binary instruction 1 and the second binary instruction 2 depending on the third binary instruction 3.

The device 108 according to the second embodiment is designed to provide an instruction to be translated, i.e., the third binary instruction 3, to the first processor 102 for translation. The first processor 102 according to the second embodiment is designed to provide the first binary instruction 1 and the second binary instruction 2 depending on the third binary instruction 3.

Optionally, the device 100 according to the second embodiment comprises the memory 112. In contrast to the memory 112 according to the first embodiment, the memory 112 according to the second embodiment comprises instructions for translating binary instructions of the third format into binary instructions of the first format and into binary instructions of the second format. The first processor 102 according to the second embodiment is designed to read the instructions from the memory 112 and to determine the first binary instruction 1 and the second binary instruction 2 depending on the instructions.

In the example, the instructions comprise a table that assigns a binary instruction of the first format and a binary instruction of the second format to a binary instruction to be translated of the third format. The first processor 102 according to the second embodiment is designed to find, in the table, the first binary instruction 1 assigned to the third binary instruction 3 to be translated in the table and the second binary instruction 2 assigned to the first binary instruction 1 in the table and to provide them to the device 108.

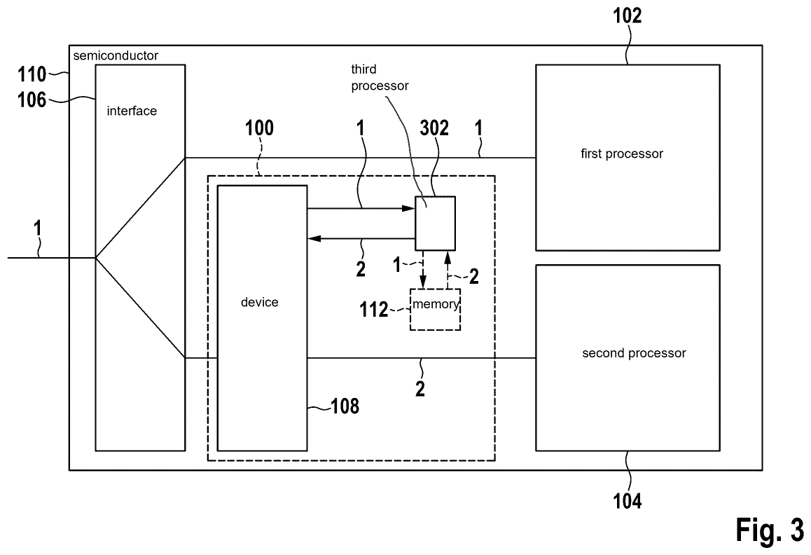

FIG. 3 schematically shows a third embodiment of the device 100 for providing binary instructions.

In contrast to the first embodiment, the device 100 according to the third embodiment comprises a third processor 302. The third processor 302 is designed to determine the translation of the first binary instruction 1 into the second binary instruction 2.

Optionally, the third processor 302 is designed to determine the second binary instruction 2 depending on the instructions from the memory 112.

For example, the third processor 302 is designed to find, in the table, the second binary instruction 2 assigned to the first binary instruction 1 in the table and to provide it to the device 108.

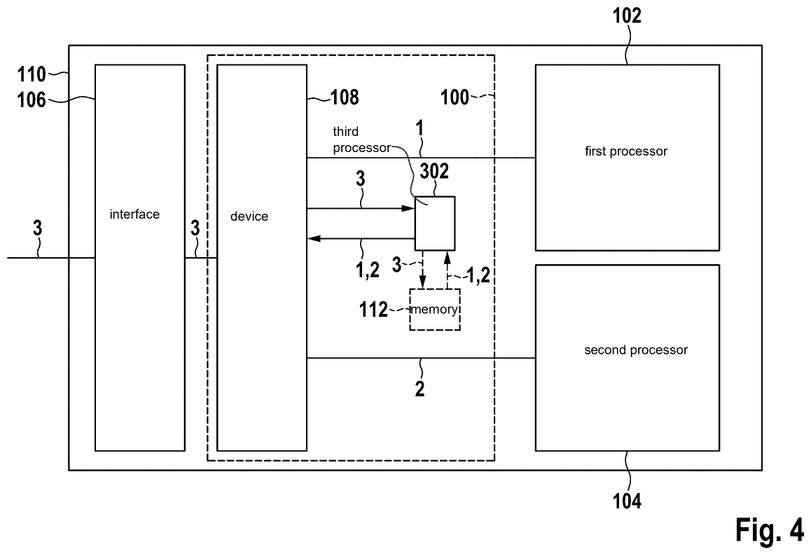

FIG. 4 schematically shows a fourth embodiment of the device 100 for providing binary instructions.

In contrast to the second embodiment, the device 100 according to the fourth embodiment comprises the third processor 302. The third processor 302 is designed to determine the translation of the third binary instruction 3 into the first binary instruction 1 and into the second binary instruction 2.

Optionally, the third processor 302 is designed to determine the first binary instruction 1 and the second binary instruction 2 depending on the instructions from the memory 112. For example, the third processor 302 is designed to find, in the table, the first binary instruction 1 assigned to the third binary instruction 3 in the table and the second binary instruction 2 assigned to the third binary instruction 3 in the table and to provide them to the device 108.

The first processor 102, the second processor 104 and either the device 108 or the third processor 302 or the device 108 and the third processor 302 are preferably implemented integrated on the semiconductor 110. Optionally, either the interface 106 or the memory 112 or the interface 106 and the memory 112 are implemented integrated on the semiconductor 110.

It can be provided that the third processor 302 is configurable for translating binary instructions of one format into binary instructions of another format. It can be provided that the device 108 is designed to configure the third processor 302 for translation.

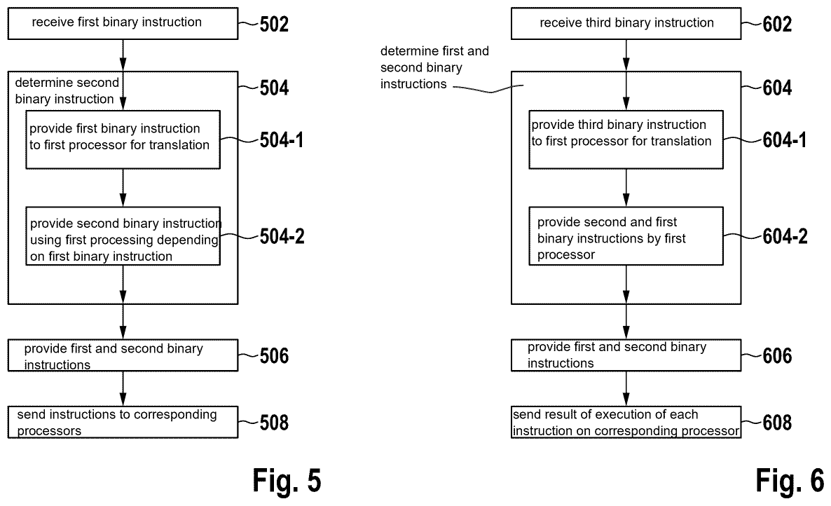

FIG. 5 shows steps according to a first embodiment of a computer-implemented method for providing binary instructions.

In a step 502, the first binary instruction 1 is received.

In a step 504, the second binary instruction 2 is determined depending on the first binary instruction 1.

In a step 504-1, the first binary instruction 1 is provided to the first processor 102 for translation.

In a step 504-2, the second binary instruction 2 is provided by means of the first processor 102 depending on the first binary instruction 1.

For example, the instructions for translation are stored in the memory 112. For example, it is provided that the instructions are read by means of the first processor 102 and the translated binary instructions are determined depending on the instructions.

For example, the instructions comprise the table. For example, it is provided that the translated binary instruction assigned to the binary instruction to be translated in the table is provided.

Instead of determining the translation by means of the first processor 102, it can be provided to determine the translation by means of the third processor 102.

It can be provided that the third processor 302 is configured to translate binary instructions of the first format into binary instructions of the second format. For example, the instructions or the table are created or supplemented with corresponding assignments.

In a step 506, the first binary instruction 1 and the second binary instruction 2 are provided.

In the example, the first binary instruction 1 is provided to the first processor 102 for execution. In the example, the second binary instruction 2 is provided to the second processor 104 for execution.

The first binary instruction 1 is provided in the first format for binary instructions executable by the first processor 102 having the first architecture.

The second binary instruction 2 is provided in the second format, different from the first format, for binary instructions executable by the second processor 104 having a second architecture different from the first architecture.

In the example, a result of the execution of each instruction on the corresponding processor is sent in a step 508.

FIG. 6 shows steps according to a second embodiment of the computer-implemented method for providing binary instructions.

In a step 602, the third binary instruction 3 is received.

In a step 604, the first binary instruction 1 and the second binary instruction 2 are determined depending on the third binary instruction 3.

In a step 604-1, the third binary instruction 3 is provided to the first processor 102 for translation.

In a step 604-2, the second binary instruction 2 and the first binary instruction 1 are provided by means of the first processor 102 depending on the third binary instruction 3.

For example, the instructions for translation are stored in the memory 112. For example, it is provided that the instructions are read by means of the first processor 102 and the translated binary instructions are determined depending on the instructions.

For example, the instructions comprise the table. For example, it is provided that the translated binary instruction assigned to the binary instruction to be translated in the table is provided.

Instead of determining the translation by means of the first processor 102, it can be provided to determine the translation by means of the third processor 102.

It can be provided that the third processor 302 is configured to translate binary instructions of the third format into binary instructions of the first format and into binary instructions of the second format.

For example, the instructions or the table are created or supplemented with corresponding assignments.

In a step 606, the first binary instruction 1 and the second binary instruction 2 are provided.

In the example, a result of the execution of each instruction on the corresponding processor is sent in a step 608.

In both methods, it can be provided that it is determined that the translation result for the translation is stored in the memory 112 and the translation result is read from the memory 112.

In both methods, it can be provided that it is determined that the translation result for the translation is unknown in the memory 112 and the translation result is calculated depending on the instructions and is stored in the memory 112.

In one embodiment, the first processor 102 or the second processor 104 comprises a hardware accelerator. The device 100 is designed to determine a configuration of the hardware accelerator depending on the at least one binary instruction 1 of the first format or the at least one binary instruction of the third format 3.

In one example, binary instructions are translated into binary instructions for execution on the first processor 102 or the second processor 104. It can be provided that the first processor 102 or the second processor 104 comprises the hardware accelerator. In this case, it can be provided that the binary instructions are also translated into binary instructions for configuring the hardware accelerator.

The hardware accelerator of a processor is designed to perform at least some of the calculations required to execute the binary instructions on this processor.

1-19. (canceled)

20. A device for automated, diversely redundant execution of binary instructions, the device comprising:
a first processor having a first architecture; and
a second processor having a second architecture'
wherein the first processor is configured to execute binary instructions of a first format,
wherein the second processor is configured to execute binary instructions of a second format different from the first format;
wherein the device is configured to provide the first processor with at least one binary instruction in the first format and to provide the second processor with at least one binary instruction in the second format that is redundant to the at least one first binary instruction, wherein the device is configured to:
(i) receive the at least one binary instruction of the first format and determine the at least one binary instruction of the second format depending on the at least one binary instruction of the first format, or (ii) receive a binary instruction redundant to the at least one binary instruction of the first format and to the at least one binary instruction of the second format, in a third format for binary instructions that is different from the first format and from the second format, and to determine the at least one binary instruction of the first format and the at least one binary instruction of the second format depending on the binary instruction of the third format.

21. The device according to claim 20, wherein:
(i) the device is configured to provide the at least one binary instruction of the first format to the first processor for translation, wherein the first processor is configured to provide the at least one binary instruction of the second format depending on the at least one instruction of the first format, or
(ii) the device is configured to provide the at least one binary instruction of the third format to the first processor for translation, wherein the first processor is configured to provide the at least one binary instruction of the first format and the at least one binary instruction of the second format depending on the binary instruction of the third format.

22. The device according to claim 20, wherein:
(i) the device is configured to provide the at least one binary instruction of the first format to a third processor for translation, wherein the third processor is configured to provide the at least one binary instruction of the second format depending on the at least one binary instruction of the first format, or
(ii) the device is configured to provide the binary instruction of the third format to the third processor for translation, wherein the third processor is configured to provide the at least one binary instruction of the first format and the at least one binary instruction of the second format depending on the binary instruction of the third format.

23. The device according to claim 22, wherein:
(i) the third processor is configurable for a translation of the at least one binary instruction of the first format into the at least one binary instruction of the second format, wherein the device is configured to configure the third processor for the translation of the at least one binary instruction of the first format into the at least one binary instruction of the second format, or
(ii) the third processor is configurable for a translation of the at least one binary instruction of the third format into the at least one binary instruction of the first format, wherein the device is configured to configure the third processor for the translation of the at least one binary instruction of the third format into the at least one binary instruction of the first format, or
(iii) the third processor is configurable for a translation of the at least one binary instruction of the third format into the at least one binary instruction of the second format, wherein the device is configured to configure the third processor for the translation of the at least one binary instruction of the third format into the at least one binary instruction of the second format.

24. The device according to claim 20, wherein:
(i) the device comprises a memory in which instructions for translating the at least one binary instruction of the first format into the at least one binary instruction of the second format are stored, wherein the device is configured to read the instructions from the memory and to determine the at least one binary instruction of the second format depending on the instructions and the at least one binary instruction of the first format, or
(ii) the device comprises a memory in which instructions for translating the at least one binary instruction of the third format into at least one binary instruction of the first format are stored, wherein the device is configured to read the instructions from the memory and to determine the at least one binary instruction of the first format depending on the instructions and the at least one binary instruction of the third format, or
(iii) the device comprises a memory in which instructions for translating the at least one binary instruction of the third format into the at least one binary instruction of the second format are stored, wherein the device is configured to read the instructions from the memory and to determine the at least one binary instruction of the second format depending on the instructions and the at least one binary instruction of the third format.

25. The device according to claim 20, wherein:
(i) the device comprises a memory in which a translation result of a translation of the at least one binary instruction of the first format into the at least one binary instruction of the second format is stored, wherein the device is configured to read the translation result from the memory and to determine the at least one binary instruction of the second format depending on the translation result, or
(ii) the device comprises a memory in which a translation result of a translation of the at least one binary instruction of the third format into the at least one binary instruction of the first format is stored, wherein the device is configured to read the translation result from the memory and to determine the at least one binary instruction of the first format depending on the translation result, or
(iii) the device comprises a memory in which a translation result of a translation of the at least one binary instruction of the third format into the at least one binary instruction of the second format is stored, wherein the device is designed to read the translation result from the memory and to determine the at least one binary instruction of the second format depending on the translation result.

26. The device according to claim 25, wherein:
(i) the memory includes a table for the translation result, the table assigning the at least one binary instruction of the second format to the at least one binary instruction of the first format, wherein the device is configured to provide the at least one binary instruction of the second format assigned to the at least one binary instruction of the first format in the table as the translation result, or
(ii) the memory includes a table for the translation result, the table assigning the at least one binary instruction of the first format to the at least one binary instruction of the third format, wherein the device is configured to provide the at least one binary instruction of the first format assigned to the at least one binary instruction of the third format in the table as the translation result, or
(iii) the memory comprises a table for the translation result, the table assigning the at least one binary instruction of the second format to the at least one binary instruction of the third format, wherein the device is configured to provide the at least one binary instruction of the second format assigned to the at least one binary instruction of the third format in the table as the translation result.

27. The device according to claim 24, wherein the device is configured to:
(i) determine that the translation result for the translation is stored in the memory and to read the translation result from the memory, or
(ii) determine that the translation result for the translation is unknown in the memory and to calculate the translation result depending on the instructions and to store it in the memory.

28. The device according to claim 20, wherein the first processor or the second processor includes a hardware accelerator, wherein the device is configured to determine a configuration of the hardware accelerator depending on the at least one binary instruction of the first format or the at least one binary instruction of the third format.

29. A computer-implemented or hardware-implemented method for automated, diversely redundant execution of binary instructions, the method comprising the following steps:
providing at least one binary instruction in a first format to a first processor, which has a first architecture and is configured to execute binary instructions of the first format;
providing at least one binary instruction in a second format, which is redundant to the at least one binary instruction of the first format to a second processor, which has a second architecture different from the first architecture and is configured to execute binary instructions of the second format different from the first format; and
(i) receiving the at least one binary instruction of the first format, and determining the at least one binary instruction of the second format depending on the at least one binary instruction of the first format, or (ii) receiving a binary instruction redundant to the at least one binary instruction of the first format and to the at least one binary instruction of the second format in a third format for binary instructions that is different from the first format and from the second format is received and determining the binary instruction of the first format and the binary instruction of the second format depending on the binary instruction of the third format.

30. The method according to claim 29, wherein:
(i) the at least one binary instruction of the first format is provided to the first processor for translation, wherein the at least one binary instruction of the second format is provided using the first processor depending on the at least one instruction of the first format, or
(ii) the at least one binary instruction of the third format is provided to the first processor for translation, wherein the at least one binary instruction of the first format and the at least one binary instruction of the second format are provided using the first processor depending on the binary instruction of the third format.

31. The method according to claim 29, wherein:
(i) the at least one binary instruction of the first format is provided to a third processor for translation, wherein the at least one binary instruction of the second format is provided using the third processor depending on the at least one binary instruction (1) of the first format, or
(ii) the binary instruction of the third format is provided to the third processor for translation, wherein the at least one binary instruction of the first format and the at least one binary instruction of the second format are provided using the third processor depending on the binary instruction of the third format.

32. The method according to claim 31, wherein:
(i) the third processor is configurable for a translation of the at least one binary instruction of the first format into the at least one binary instruction of the second format, wherein the third processor is configured for the translation of the at least one binary instruction of the first format into the at least one binary instruction of the second format, or
(ii) the third processor is configurable for a translation of the at least one binary instruction of the third format into the at least one binary instruction of the first format, wherein the third processor is configured for the translation of the at least one binary instruction of the third format into the at least one binary instruction of the first format, or
(iii) the third processor is configurable for a translation of the at least one binary instruction of the third format into the at least one binary instruction of the second format, wherein the third processor is configured for the translation of the at least one binary instruction of the third format into the at least one binary instruction of the second format.

33. The method according to claim 29, wherein:
(i) instructions for translating the at least one binary instruction of the first format into the at least one binary instruction of the second format are stored in a memory, wherein the instructions are read from the memory and the at least one binary instruction of the second format is determined depending on the instructions and the at least one binary instruction of the first format, or
(ii) instructions for translating the at least one binary instruction of the third format into at least one binary instruction of the first format are stored in a memory, wherein the instructions are read from the memory and the at least one binary instruction of the first format is determined depending on the instructions and the at least one binary instruction of the third format, or
(iii) instructions for translating the at least one binary instruction of the third format into the at least one binary instruction of the second format are stored in a memory, wherein the instructions are read from the memory and the at least one binary instruction of the second format is determined depending on the instructions and the at least one binary instruction of the third format.

34. The method according to claim 29, wherein:
(i) a translation result of a translation of the at least one binary instruction of the first format into the at least one binary instruction of the second format is stored in a memory, wherein the translation result is read from the memory and the at least one binary instruction of the second format is determined depending on the translation result, or
(ii) a translation result of a translation of the at least one binary instruction of the third format into the at least one binary instruction of the first format is stored in a memory, wherein the translation result is read from the memory and the at least one binary instruction of the first format is determined depending on the translation result, or
(iii) a translation result of a translation of the at least one binary instruction of the third format into the at least one binary instruction of the second format is stored in a memory, wherein the translation result is read from the memory and the at least one binary instruction of the second format is determined depending on the translation result.

35. The method according to claim 34, wherein:
(i) the memory comprises a table for the translation result, the table assigning the at least one binary instruction of the second format to the at least one binary instruction of the first format, wherein the at least one binary instruction of the second format assigned to the at least one binary instruction of the first format in the table is provided as the translation result, or
(ii) the memory comprises a table for the translation result, the table assigning the at least one binary instruction of the first format to the at least one binary instruction of the third format, wherein the at least one binary instruction of the first format assigned to the at least one binary instruction of the third format in the table is provided as the translation result, or
(iii) the memory comprises a table for the translation result, the table assigning the at least one binary instruction of the second format to the at least one binary instruction of the third format, wherein the at least one binary instruction of the second format assigned to the at least one binary instruction of the third format in the table is provided as the translation result.

36. The method according to claim 33, wherein:
(i) it is determined that the translation result for the translation is stored in the memory and the translation result is read from the memory, or
(ii) it is determined that the translation result for the translation is unknown in the memory and the translation result is calculated depending on the instructions and stored in the memory.

37. The method according to claim 29, wherein the first processor or the second processor includes a hardware accelerator, wherein a configuration of the hardware accelerator is determined depending on the at least one binary instruction of the first format or the at least one binary instruction of the third format.

38. A non-transitory machine-readable medium on which is stored a program including computer-readable instructions for automated, diversely redundant execution of binary instructions, the instructions, when executed by a computer, causing the computer to perform the following steps comprising:
providing at least one binary instruction in a first format to a first processor, which has a first architecture and is configured to execute binary instructions of the first format;
providing at least one binary instruction in a second format, which is redundant to the at least one binary instruction of the first format to a second processor, which has a second architecture different from the first architecture and is configured to execute binary instructions of the second format different from the first format; and
(i) receiving the at least one binary instruction of the first format, and determining the at least one binary instruction of the second format depending on the at least one binary instruction of the first format, or (ii) receiving a binary instruction redundant to the at least one binary instruction of the first format and to the at least one binary instruction of the second format in a third format for binary instructions that is different from the first format and from the second format is received and determining the binary instruction of the first format and the binary instruction of the second format depending on the binary instruction of the third format
